(19) United States
(12) Patent Application Publication
(10) Pub. No.: US 2012/0167137 A1
(43) Pub. Date: Jun. 28, 2012

(54) SYSTEM AND METHOD FOR AUTOMATED SOCIAL NETWORKING

(75) Inventors: Ling Jun Wong, Escondido, CA (US); True Xiong, San Diego, CA (US)

(73) Assignee: SONY CORPORATION, Tokyo (JP)

(21) Appl. No.: 12/975,861

(22) Filed: Dec. 22, 2010

(51) Int. Cl. H04N 5/445; G06F 15/16; H04N 7/173

(52) U.S. Cl. 725/38; 725/109; 725/112; 709/203; 709/231

(57) ABSTRACT

A system for sending content between a TV (e.g. IPTV or the like) and a website. The system includes an interface server and a TV that includes display, processor and an interface module for communicating with the interface server. The system also has programming executable on the interface server for coupling the server to a social networking website, providing a graphical user interface (e.g. in the form of an app) on the social networking site for linking to said TV, and sending content from the social networking site to the TV. The system also has programming executable on the TV processor for displaying a notification that content has been received; and displaying the content upon selection by a user.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to content delivery, and more particularly to content delivery to and from social networking websites.

2. Description of Related Art

News feeds to social networking sites are popular and common, but do not provide for direct link to a non-PC internet enabled devices (TV, BDP, DASH etc) from a news feed is something that is new.

Accordingly, an object of the present invention is a system for allowing direct linking of content to and from a TV to a social networking website. At least some of these objections will be met in the following description.

### BRIEF SUMMARY OF THE INVENTION

The present invention comprises system and methods utilizing an Internet connection for allowing a user to submit news feeds to popular social networking sites like Facebook, twitter and mySpace while they're using an IPTV or like device.

The user can select a news feed from another device user to allow the user to view that piece of content on his/her own IPTV unit directly without having to navigate to that through an Interned connection service or web page.

One aspect is a system for sending content between a TV and a website, comprising: a TV and an interface server; the TV having a display, processor and an interface module for communicating with the interface server. The system further includes programming executable on the interface server for carrying out the steps of coupling the server to a social networking website; providing a graphical user interface on said social networking site for linking to the TV; sending content from said social networking site to the TV. In addition, the system includes programming executable on the TV processor for carrying out the steps of: displaying a notification on the display that content has been received; and displaying the content on said the upon selection by a user

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of a consumer electronics social networking content delivery system in accordance with the present invention.

FIG. 2 illustrates a method for uploading a news feed from a consumer device.

FIG. 3 is a flow diagram of a method for linking social networking website to a consumer device in accordance with the present invention.

FIG. 4 is a flow diagram of a method for delivering content from a social networking website to a consumer device in accordance with the present invention.

FIG. 5 shows a content delivery and notification graphical interface in accordance with the present invention.

### DETAILED DESCRIPTION OF THE INVENTION

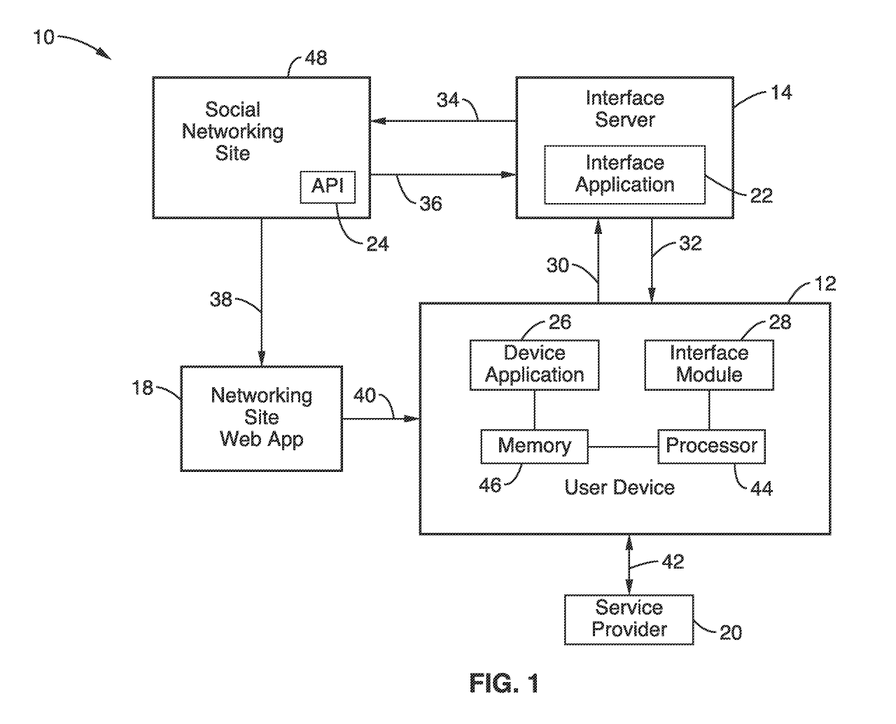

Referring more specifically to the drawings, for illustrative purposes the present invention is embodied in the apparatus generally shown in FIG. 1 through FIG. 5. It will be appreciated that the apparatus may vary as to configuration and as to details of the parts, and that the method may vary as to the specific steps and sequence, without departing from the basic concepts as disclosed herein.

FIG. 1 illustrates a schematic diagram of a consumer electronics social networking content delivery system 10 in accordance with the present invention. The system 10 comprises a user device 12 having device application software 26 configured for coupling the device 12 to a network via an interface module 28. Application software 26 also comprises graphic user interface functionality for allowing a user to operate device 12 and the features of application software 26.

Device 12 comprises memory 46 for storing device application 26 and processor 44 for operating the application 26. Device processor 44 is configured to process commands initiated by the application 26 to communicate with a remote device (e.g. interface server 14) over a network such as the Internet 46.

The device 12 preferably comprises an interface module 28 that allows the device 12 to communicate with other devices such as server 14. In a preferred embodiment, the interface module 28 comprises a BRAVIA Internet Video (BIVL) module that may be an integrated or add-on component for the device 12. The interface module 28 may comprise software which allows the device 12 to communicate with other remote systems and device over the Internet or like network. It is also appreciated, that the other types of interface systems (non BRAVIA) may be incorporated to allow the device to communicate over the network.

Interface module 28 is configured to communicate with interface server 14 to send data signals 30 and receive data signals 32 via interface application 22. Interface module is also configured to send or receive signals 40, 42 directly from website 48 or service provider 20, respectively.

In a preferred embodiment, device 12 comprises a TV, such as an IPTV or the like. However, it is appreciated that the device 12 may comprise any one of a number of different consumer devices, e.g. cell phone, computer, set top box, or the like.

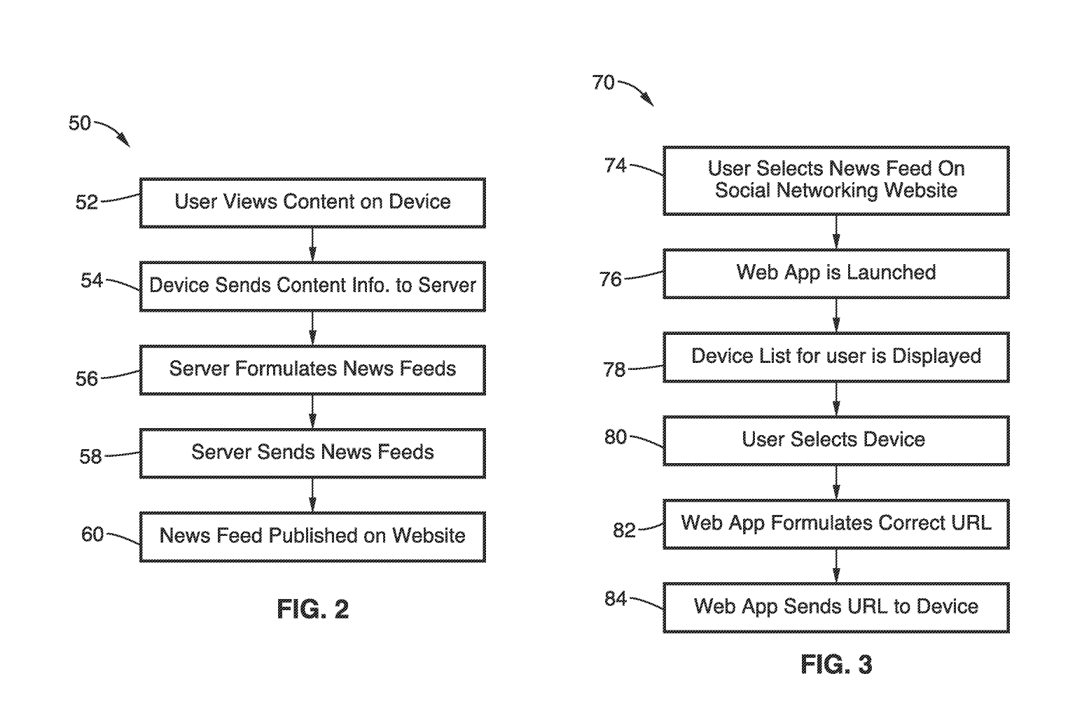

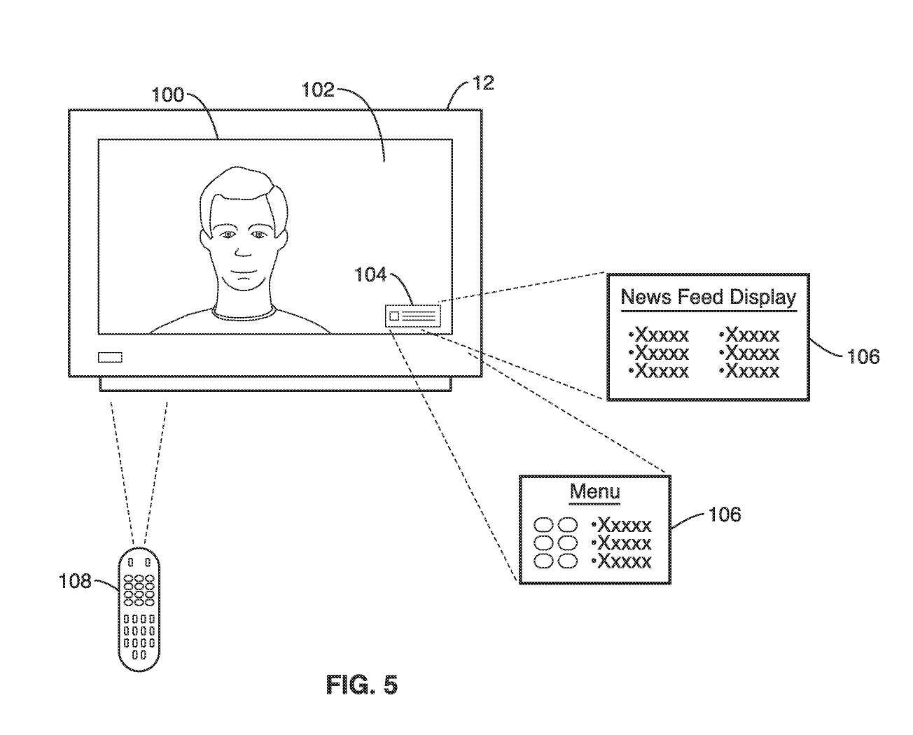

FIG. 2 illustrates a method 50 for uploading a news feed from a consumer device 21 to a social networking website 48 in accordance with the present invention. In step 52, a user watches content on the device 12 (e.g. IPTV). If the user desires to upload the content (e.g. streaming video, news feed, or the like), the user may direct the application software 26 (e.g. through on screen programming shown FIG. 5 and described in further detail below) the device 12 sends content info 32 to interface server 14 at step 54.

At step 56, the interface application 22 of interface server 14 formulates the content 32 from the device (e.g. news feed) and sends the formulated content 34 at step 58 to one or more social networking sites 48 based on their published API 24. The formulated content 34 has embedded information to identify the content 34 according to parameters set by the API 24. For example, in the case of content 34 comprising a news feed, the application interface 22 will embed data that allows the API 24 to recognize the news feed and process it accordingly. In step 60, the content 34 gets posted on the website 48, (e.g. the media is uploaded or news feed is published)

FIG. 3 shows a method 70 for sending content to a device 12 (e.g. IPTV) from a social networking site 48 news feed (e.g. Facebook, Twitter, Myspace, etc.). At step 74, a user selects link, news feed, or other content 38 in social networking site 48 for upload to a device 12. The networking site web app 28 (which is specific to the networking site (e.g. Facebook, Twitter, etc) is then launched at step 76.

At step 78, the networking site web app 28 generates a device list for the user to select. The device list may be a list of available networked devices that the user has coupled to the network. At step 80, the user selects a device (e.g. device 12), or a plurality of devices from the list of devices to upload the content. These devices may be established under an account providing the service specific to the user.

At step 82, the networking site web app 28 formulates a local URL for playback. An exemplary URL may read as follows:

https://192.168.03
/play?url=xxx
asset_id=123
service_id=Netflix

At step 84, the networking site web app 28 sends the URL 40 to the device 12 which is in the same network as the computer running the app 18. It is appreciated that web application 28 may comprise a graphical user interface that resides in memory on the interface server 14 or other server coupled to the network, and is configured to interface with the API 24 of the website 48.

Method 70 is preferred for applications such as Facebook, because it requires less resources and gives the user a choice to select the device 12.

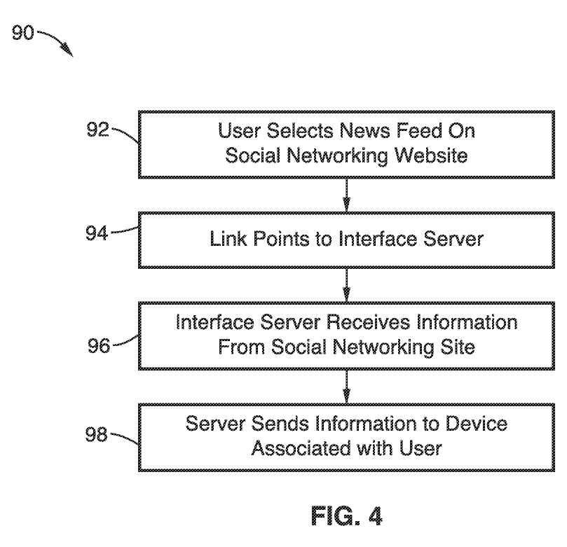

FIG. 4 illustrates a method 90 for sending content to a device from social networking news feeds (for other social networking sites, which may also include Facebook). At step 92, the user selects a news feed of interest in social networking site. At step 94, the link 36 points to the interface server 14. At step 98, the interface application 22 on server 14 then sends data 32 (e.g. local url or asset_id & service_id) down to the device 12 (e.g. IPTV) for viewing. The communication channel between server 14 and device 12 may be via XMPP or IPTV polling.

Because there is generally not an option for a user to select a device in method 90, this configuration may generally comprise a one-to-one relationship, i.e. one device to one social networking account. However, it is anticipated that that a multiple-device to single account relationship may also be supported. For example, when the user clicks on the URL, the app 18 may be configured to forward the user to a page allowing the user to select a device 12 from among a plurality of devices. This will then create the actual playback URL that will be sent to that device 12.

As shown in FIG. 1, device 12 may also have direct content/url retrieval 42 via service provider 20.

FIG. 5 shows a content delivery and notification graphical interface in accordance with the present invention. Device 12 is illustrated as an IPTV or like device having a display 100. A notification window 104 may be imaged over general program 102 for notification or viewing by a user. For example, a news feed display 108 may be imaged periodically or continuously displayed in a region 104 of the display 100. The user may be able to zoom in or expand to a larger window 106 if desired to view content (e.g. news feed, video or other content). The user may be able to select a link to the feed, such that video or other content will automatically be played on the user's device 12. This saves the users from going through the trouble of looking for that piece of content in the huge list of services. When the user selects the link, the information is passed to the interface server 14, which then sends the link down to the corresponding device 12 that is currently active. If it is not active, this link may be stored and sent down the next time the device 12 becomes active.

In addition to being pushed to the device 12 as described above, content may also be pulled from a website 48. Menu 106 may also be available to allow the user to browse for content via remote 108, or otherwise control or access data relating to a website 48.

Notification window 104 may be customized by the user to turn on or off during certain circumstances (e.g. certain posts or friends within social network). The notification window 104 may also be configured to auto-update, such that notification window 104 may be configured to automatically display when a new message/post arrives at a user's account. The new message notification 104 may simply comprise an icon, or may include some identification of the newly posted content, (e.g. subject, data type, sender, etc.).

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

As can be seen, therefore, the present invention includes the following inventive embodiments among others:

1. A system for sending content between a television (TV) and a website, comprising: (a) a TV; (b) an interface server; (c) said TV comprising a display, processor and an interface module for communicating with said interface server; (d) programming executable on said interface server for carrying out steps comprising: coupling the server to a social networking website; providing a graphical user interface on said social networking site for linking to said TV; and sending content from said social networking site to the TV; and (e) programming executable on said TV processor for carrying out steps comprising: displaying a notification on said display that content has been received; and displaying said content on said display upon selection by a user.

2. A system as recited in embodiment 1, wherein said content comprises a news feed from said social networking website.

3. A system as recited in embodiment 2, wherein said content comprises streaming video.

4. A system as recited in embodiment 1, wherein the programming executable on said interface server is further configured to: provide a link on said social networking website, wherein said link points to the interface server; wherein upon selection of said link, the interface server receives said content and sends the content down to the TV.

5. A system as recited in embodiment 4, wherein content is sent between the interface server and the website via XMPP or IPTV polling.

6. A system as recited in embodiment 1: wherein said graphical user interface is launched upon a user selecting a news feed in the social networking website; wherein the graphical user interface comprises an application configured to provide a list of devices, including said TV, for the to select; the list of devices comprising devices being associated with the user that may be selectable by the user for sending said content; and wherein, upon said user selecting a device from the list of devices, said application generates a local URL and sends it to the selected device for playback of said content.

7. A system as recited in embodiment 6: wherein said device comprises said TV; and wherein said URL is linked to said displayed notification.

8. A system as recited in embodiment 1, wherein the programming executable on said TV processor is further configured to transfer content data to the interface server.

9. A system as recited in embodiment 8: wherein the programming executable on said interface server is configured to formulate the transferred content data sends it to a website; and wherein said transferred content data is formulated according to a published API of the website.

10. A system for sending content between a television (TV) and a website, comprising: (a) a TV; (b) an interface server; (c) said TV comprising a display, processor and an interface module for communicating with said interface server; (d) programming executable on said TV processor configured to transfer content data to the interface server; and (e) programming executable on said interface server for carrying out steps comprising: coupling the server to a website; formulating the transferred content data according to a published API of the website sends it to a website; and sending the formulated content data to the website.

11. A system as recited in embodiment 10: wherein said content comprises a news feed; and wherein said programming executable on said interface server is configured to publish the content on the website.

12. A system as recited in embodiment 11, wherein said content comprises streaming video.

13. A system as recited in embodiment 11: wherein said programming executable on said interface server is further configured to carry out steps comprising: providing a graphical user interface on said website for linking to said TV; sending content from said website to the TV; and wherein said programming executable on said TV processor is configured for carrying out steps comprising: displaying a notification on said display that content has been received; and displaying said content on said display upon selection by a user.

14. A system as recited in embodiment 11: wherein the programming executable on said interface server is further configured to: provide a link on said website, wherein said link points to the interface server; wherein upon selection of said link, the interface server receives said content and sends the content down to the TV.

15. A system as recited in embodiment 4, wherein content is sent between the interface server and the website via XMPP or IPTV polling.

16. A system as recited in embodiment 14: wherein said graphical user interface is launched upon a user selecting a news feed in the social networking website; wherein the graphical user interface comprises an application configured to provide a list of devices, including said TV, for the to select; the list of devices comprising devices being associated with the user that may be selectable by the user for sending said content; and wherein, upon said user selecting a device from the list of devices, said application generates a local URL and sends it to the selected device for playback of said content.

17. A system as recited in embodiment 16: wherein said device comprises said TV; and wherein said URL is linked to said displayed notification.

18. An Internet enabled television (TV), comprising: a display; a processor; an interface module for communicating with a website over the internet; and programming executable on said processor for carrying out steps comprising: selecting a media content; formulating data relating to the content data according to a published API of the website coupled to the Internet; and transferring said content data to the website.

19. A TV as recited in embodiment 18: wherein said content comprises a news feed; and wherein said programming executable on said processor is configured to publish the content on the website.

20. A TV as recited in embodiment 18, wherein the programming executable on the processor is further configured for carrying out steps comprising: receiving content data from said website; displaying a notification on said display that content has been received; and displaying said content on said display upon selection by a user.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for sending content between a television (TV) and a website, comprising:
a TV;
an interface server;
said TV comprising a display, processor and an interface module for communicating with said interface server;
programming executable on said interface server for carrying out steps comprising:
coupling the server to a social networking website;
providing a graphical user interface on said social networking site for linking to said TV; and
sending content from said social networking site to the TV; and
programming executable on said TV processor for carrying out steps comprising:
displaying a notification on said display that content has been received; and
displaying said content on said display upon selection by a user.

2. A system as recited in claim 1, wherein said content comprises a news feed from said social networking website.

3. A system as recited in claim 2, wherein said content comprises streaming video.

4. A system as recited in claim 1, wherein the programming executable on said interface server is further configured to:
provide a link on said social networking website, wherein said link points to the interface server;
wherein upon selection of said link, the interface server receives said content and sends the content down to the TV.

5. A system as recited in claim 4, wherein content is sent between the interface server and the website via XMPP or IPTV polling.

6. A system as recited in claim 1:
wherein said graphical user interface is launched upon a user selecting a news feed in the social networking website;
wherein the graphical user interface comprises an application configured to provide a list of devices, including said TV, for the to select;
the list of devices comprising devices being associated with the user that may be selectable by the user for sending said content; and
wherein, upon said user selecting a device from the list of devices, said application generates a local URL and sends it to the selected device for playback of said content.

7. A system as recited in claim 6:
wherein said device comprises said TV; and
wherein said URL is linked to said displayed notification.

8. A system as recited in claim 1, wherein the programming executable on said TV processor is further configured to transfer content data to the interface server.

9. A system as recited in claim 8:
wherein the programming executable on said interface server is configured to formulate the transferred content data sends it to a website; and
wherein said transferred content data is formulated according to a published API of the website.

10. A system for sending content between a television (TV) and a website, comprising:
a TV;
an interface server;
said TV comprising a display, processor and an interface module for communicating with said interface server;
programming executable on said TV processor configured to transfer content data to the interface server; and
programming executable on said interface server for carrying out steps comprising:
coupling the server to a website;
formulating the transferred content data according to a published API of the website sends it to a website; and
sending the formulated content data to the website.

11. A system as recited in claim 10:
wherein said content comprises a news feed; and
wherein said programming executable on said interface server is configured to publish the content on the website.

12. A system as recited in claim 11, wherein said content comprises streaming video.

13. A system as recited in claim 11:
wherein said programming executable on said interface server is further configured to carry out steps comprising:
providing a graphical user interface on said website for linking to said TV;
sending content from said website to the TV; and
wherein said programming executable on said TV processor is configured for carrying out steps comprising:
displaying a notification on said display that content has been received; and
displaying said content on said display upon selection by a user.

14. A system as recited in claim 11:
wherein the programming executable on said interface server is further configured to:
provide a link on said website, wherein said link points to the interface server;
wherein upon selection of said link, the interface server receives said content and sends the content down to the TV.

15. A system as recited in claim 4, wherein content is sent between the interface server and the website via XMPP or IPTV polling.

16. A system as recited in claim 14:
wherein said graphical user interface is launched upon a user selecting a news feed in the social networking website;
wherein the graphical user interface comprises an application configured to provide a list of devices, including said TV, for the to select;
the list of devices comprising devices being associated with the user that may be selectable by the user for sending said content; and
wherein, upon said user selecting a device from the list of devices, said application generates a local URL and sends it to the selected device for playback of said content.

17. A system as recited in claim 16:
wherein said device comprises said TV; and
wherein said URL is linked to said displayed notification.

18. An Internet enabled television (TV), comprising:
a display;
a processor;
an interface module for communicating with a website over the internet; and
programming executable on said processor for carrying out steps comprising:
selecting a media content;
formulating data relating to the content data according to a published API of the website coupled to the Internet; and
transferring said content data to the website.

19. A TV as recited in claim 18:
wherein said content comprises a news feed; and
wherein said programming executable on said processor is configured to publish the content on the website.

20. A TV as recited in claim 18, wherein the programming executable on the processor is further configured for carrying out steps comprising:
receiving content data from said website;
displaying a notification on said display that content has been received; and
displaying said content on said display upon selection by a user.
